(19) United States
(12) Patent Application Publication
(10) Pub. No.: US 2008/0032266 A1
(43) Pub. Date: Feb. 7, 2008

(54) Superstructure Body for a Dental Crown Superstructure System

(76) Inventor: Harald E. Harlass, Freden/Leine (DE)

Correspondence Address: SIMPSON & SIMPSON, PLLC, 5555 MAIN STREET, WILLIAMSVILLE, NY, 14221-5406, US

(21) Appl. No.: 11/632,782

(22) PCT Filed: Jul. 18, 2005
(86) PCT No.: PCT/EP05/07807

§ 371 Date: Jan. 18, 2007

(30) Foreign Application Priority Data
Jul. 19, 2004 (DE) 10 2004 034 800.6
Sep. 17, 2004 (DE) 20 2004 014 491.3

(51) Int. Cl. A61C 5/08

(52) U.S. Cl. 433/219

(57) ABSTRACT

The present invention is a superstructure body for a dental crown superstructure system on a treated tooth stump and/or dental root. The treated tooth includes a bore or recess in which the superstructure body is inserted. The superstructure body includes a through-bore which provides access to the root canal of the tooth stump. A dental crown or overlay may be mounted on the superstructure body.

### CROSS-REFERENCE TO RELATED APPLICATIONS

The present application claims the benefit under 35 U.S.C. §371 of PCT Application No. PCT/EP/2005/007807, filed Jul. 18, 2005, which is hereby incorporated by reference in its entirety and which claims priority to German Applications Nos. DE 10 2004 034 800.6, filed Jul. 19, 2004, and DE 20 2004 014 491.3, filed Sep. 17, 2004.

### FIELD OF THE INVENTION

The present invention relates to a superstructure body for a dental crown superstructure system on a tooth stump/dental root.

### BACKGROUND OF THE INVENTION

The systems to construct a dental crown known so far all have in common that a screw, a pin or similar is fixed in the endodontically prepared root canal after preparation including smoothening of the tooth stump, and the dental crown is subsequently fixed on this screw or this pin. To this end, it is required at first to treat the root canal conclusively which, as a general rule in case of an infected root canal, happens during three chronologically subsequent sessions during which the root canal is rinsed, mechanically cleaned and treated with medication. Therefore, in case of a fractured tooth, a provisional appliance, which is only difficult to firmly anchor, is required at first to keep the root canal accessible. In addition, anchorage of a dental crown in the root canal is not optimal for reasons of physical strength due to the small contact surfaces, since the screw or the pin respectively exerts a high pressure on the edge of the root canal.

### SUMMARY OF THE INVENTION

The object of the present invention is to create a superstructure body that facilitates the construction of a dental crown and offers improved strength characteristics.

The object according to the invention is solved by a superstructure body of the type described by way of introduction which has a rotationally symmetrical end region whose diameter is significantly larger than the diameter of the root canal and is anchorable in a corresponding bore in the tooth stump, and a through bore is provided in the superstructure body whose one exit opening located in a front surface of the end region is arranged so that it corresponds with an access to the opening of the root canal after insertion.

The solution according to the invention offers two advantages. At first the end region provided with a significantly larger diameter compared to the root canal allows a large-area anchorage of the superstructure body in a bore correspondingly inserted into the tooth stump, and on the other hand the through-bore in the superstructure body allows access to the root canal even after its anchorage onto the tooth stump, so that it can still be treated endodontically during subsequent sessions despite the construction of the dental crown already begun. The superstructure body may be mounted in the bore in the dentin of the tooth stump by gluing or cementing in a known manner per se.

In case of monoradicular teeth, a simple through-bore can align with the root canal opening, so that the root canal remains accessible without further action. Another embodiment of the invention provides that the bore is expanded towards the front surface of the end region, preferably to an elongated hole or conical. This allows direct access to the root canal even in case of a root canal opening laterally displaced to the bore opening or in case of multi-rooted teeth. However, it also possible for a dentist to expand the bore towards the front surface in the required manner without much action by means of the tools available to the dentist.

In a particularly preferred embodiment for monoradicular teeth, the through-bore is arranged centrically in the rotationally symmetrical end region. In this way, it is easily possible for a dentist to create the cylinder-shaped recess in the desired diameter by means of a self-centring bur/milling cutter, e.g. a spot facer, available in his pool as a general rule, whereas the root canal of the tooth can be used to center the bore and accordingly the through-bore is automatically in line with the root canal exit when the superstructure body is subsequently inserted. In case of multi-rooted teeth, the boring/milling is carried out in the center of the front surface of the tooth by sense of proportion, with the already aforementioned superstructure body with expanded bore being preferably used.

Another preferred embodiment of the invention provides that the superstructure body has an expanded region attached to the end region. While bores should be arranged at a certain minimum distance to the outer surface especially for the treatment of incisor teeth in the dentin of the tooth stump also for reasons of physical strength in order not to endanger the strength of the tooth stump, it may be reasonable to effect the expanded region projecting into the oral cavity with a larger cross-section in order having to use less material for the construction of a tooth-colored dental crown for example when using tooth-colored composites. The cross-sectional expansion between the end region and the expanded region is preferably designed as a shoulder having a surface arranged normal to the centerline of the superstructure body, since this surface adjacent to a plan surface of the tooth stump further improves the strength of the anchorage of the superstructure body onto the tooth stump. The expanded region projecting into the oral cavity can have a cylindrical cross-section which is preferably designed concentrically to the end region. Such a design offers the advantage that the superstructure body can be used in any angular position. In addition, the rotationally symmetrical design of the entire superstructure body offers advantages for its production. It is, however, also conceivable to select other cross-sectional shapes for the expanded region, for example elliptic shapes or also cross-sections that are already designed for the connection with prefabricated elements in a certain manner, for example a Frasacostrip dental crown using appropriate fasteners.

Basically, however, it is also conceivable for a particularly simple embodiment of the invention that the superstructure body is continuously designed as a cylinder having a diameter corresponding to the end region.

In case of monoradicular teeth, the diameter of the through-bore has a diameter of preferably approximately 1 mm which essentially corresponds to the root canal diameter of a human tooth. However, deviations therefrom are possible, if for example in the veterinary medical field the superstructure body is to be used for an animal with different tooth dimensions whose root canals have different diameters. The dimensions of the internal bore are restricted by the decreasing strength of the superstructure body in case of a diameter selected too large on one hand and by the obstruction of the accessibility of the root canal in case of constriction on the other hand.

As already indicated, the end region preferably has a cylindrical form. This enables the use of simple boring/milling tools that as a general rule are available at any dentist.

However, it is also conceivable to design the end region frustoconically, which may possibly be reasonable to improve the strength of the anchorage. As a general rule, however, a cylindrical adhesive or cementing surface is sufficient.

The afore-described superstructure body need not necessarily be designed in one piece, but may also consist of two individual cylinder bodies with internal bores, with one piece being mounted inside or onto the tooth stump at first and the second part being subsequently glued or inserted in an appropriate manner. The second part may be operatively arranged such that it protrudes from the tooth stump after having been fixed to the first part. The superstructure body may further be designed such that it has more than two parts.

The superstructure body can be made of the materials already known in the dental field whose mechanical properties correspond to those of dentin or are at least similar thereto.

With respect to the construction of the dental crown, the material should preferably also be abrasively easy to model and/or appropriate for the application of composite materials. Further, the superstructure body should be made of a material that is appropriate for remaining underneath a prosthetic provisional body, such as a dental crown or overlay.

Appropriate materials for the superstructure body may be thermoplastic or thermosetting material. When using thermoplastic material, a cost-efficient injection molding process is useful for the manufacture of the superstructure body, while in the case of thermosetting material the plastic made from monomers is cured in an appropriate shape in a usual curing process.

Representative examples of thermoplastic materials that may be used include: a polyamide consisting of a condensation polymer of a bivalent alkane acid and a bivalent alkanamine, such as polyhexamethylenediamineadipate; a polyester consisting of a condensation polymer of a bivalent organic acid and a bivalent organic hydroxy compound, such as polyethyleneglycolterephtalate or polyethyleneglycol naphthalene carboxylic acid ester; and, a polycarbonate consisting of a condensation polymer of carbonic acid and a bivalent organic hydroxy compound. The thermoplastic may be a copolymer of polyester and polyamide. The thermoplastic may also be a polyether, such as polymethylene oxide or poly-ether-ether-ketone.

Representative examples of thermosetting materials that may be used include an epoxy resin, such as a triglyceride of bisphenol-A, or a polyacrylate consisting of acrylic acid glycerid ester containing at least three acrylic esters, or an alkyd resin.

### BRIEF DESCRIPTION OF THE DRAWINGS

An embodiment of the present invention will now be described with reference to the accompanying drawings, in which

FIG. 1 depicts a longitudinal section of a fractured tooth;

FIG. 2 depicts the tooth of FIG. 1 after planing;

FIG. 3a depicts a longitudinal section of the tooth shown in FIG. 2 after inserting a bore;

FIG. 3b is a plan view of the bore shown in FIG. 3a;

FIG. 4a depicts a cross-section of the tooth shown in FIG. 3a with a mounted superstructure body;

FIG. 4b is a plan view of the mounted superstructure shown in FIG. 4a;

FIG. 5 depicts a longitudinal section of the tooth with the superstructure body shown in FIG. 4a that has been processed;

FIG. 6 depicts a longitudinal section of the tooth shown in FIG. 5 with a completed dental crown mounted on the superstructure body;

FIG. 7a is a schematic view of a bur having a wing form used for creating a bore in a tooth stump;

FIG. 7b is a schematic view of a bur that may be used to produce a barrel shaped bore in a tooth stump;

FIG. 8a is a partial cut side view of a first embodiment of the superstructure body having a cylindrical first end region;

FIG. 8b is a partial cut side view of a second embodiment of the superstructure body having a frustoconical first end region; and,

FIG. 9 depicts a view of a pin for insertion into the bore of the superstructure body.

### DETAILED DESCRIPTION OF THE PREFERRED EMBODIMENT

FIG. 1 shows a longitudinal section of tooth 10 that for example is heavily fractured as a result of an accident. Tooth 10 consists of main body 12 made of dentin and outer layer of dental cement 14, while root canal 16 establishes a connection to the nerve of tooth 10 in its interior.

To construct a new dental crown on fractured tooth 10, the fractured region is removed in a first step by planning, thereby creating planar root surface 18 that is orthogonal with respect to the course of root canal 16 and is located approximately at the level of the gingiva in the case of typical tooth fractures.

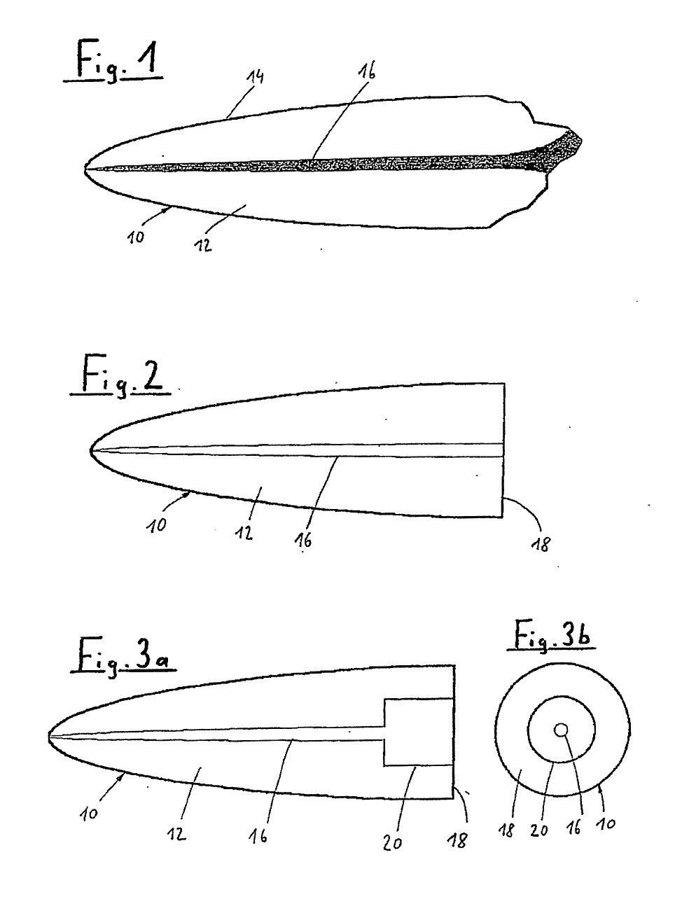

Subsequently, cylinder-shaped bore 20 (see FIG. 2), which is aligned concentrically to root canal 16, is drilled into the dentin using a rotating dental instrument, such as a bur. The cross-sectional size of cylinder-shaped bore 20 can in the cross-section depend upon the particular tooth to be treated, whereas a dentinal wall thickness of about 2 mm or more should remain around bore 20 for reasons of physical strength.

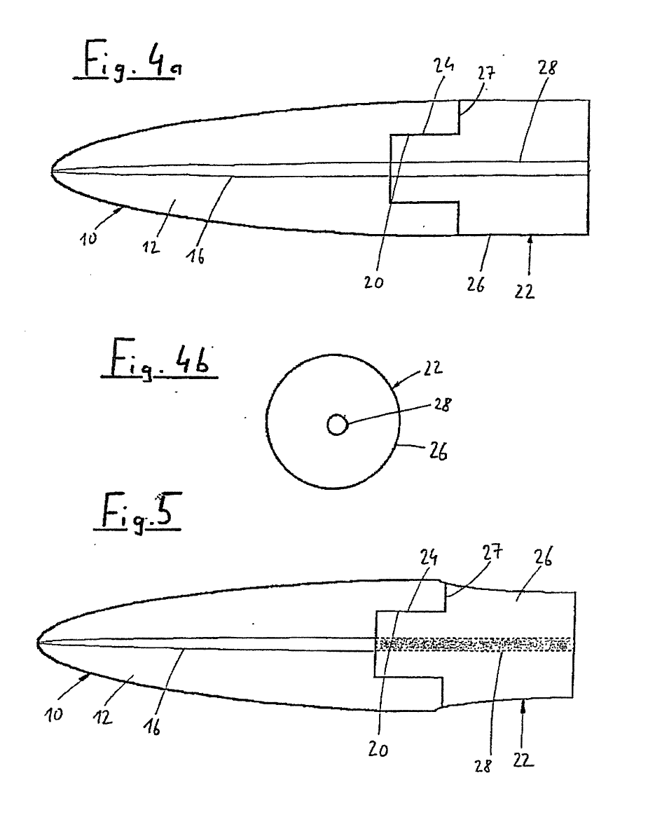

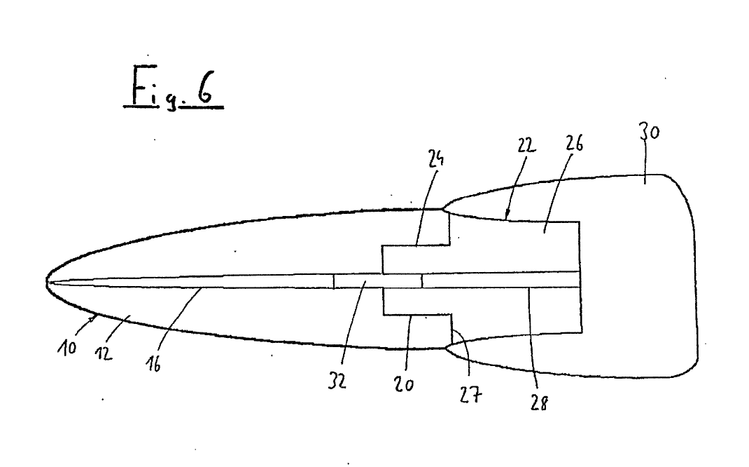

An industrially prefabricated superstructure body 22 can then be inserted into bore 20, for example by gluing or cementing. In one embodiment of the present invention, as shown in FIGS. 1-6, superstructure body 22 is the form of a stepped cylinder, which consists of smaller cylindrical end region 24 having an outer diameter adapted to the diameter of bore 20 in the dentin, and expanded cylindrical region 26. Together, end region 24 and expanded region 26 define shoulder 27 having a surface that is arranged substantially orthogonal with respect to the central longitudinal axis of cylinder 22. As the stepped cylinder design serves as an exemplary embodiment of superstructure body 22, hereinafter, stepped cylinder 22 will be used interchangeably with superstructure body 22, unless another embodiment is being described.

The radial length of shoulder 27 is about 2 mm, but may be adapted to the dimensions of tooth 10 to be treated, where required, particularly if a dentinal wall thickness deviating from the aforementioned 2 mm is selected. Significant deviations high or low therefrom are conceivable particularly in the veterinary medical field. Stepped cylinder 22 is made of a material similar to dentin with regard to its strength characteristics, so that the desired strength values are given on one hand, while stepped cylinder 22, however, can also be modelled with the usual dental instruments on the other hand.

Particularly convenient is through-bore 28 disposed centrically in stepped cylinder 22. Through-bore 28 is arranged in line with root canal 16 after gluing or cementing stepped cylinder 22 in bore 20 conforming with the concentric design of bore 20 with respect to root canal 16, so that root canal 16 remains accessible by means of through-bore 28 after mounting stepped cylinder 22 on the tooth stump. This offers the advantage that construction of the dental crown on the dental root can be initiated during a first treatment session, and treatment of the root canal remains possible during subsequent treatment sessions. Through-bore 28 of stepped cylinder 22 has a diameter of for example 1 mm for human incisor teeth, however, adjustments based on the particular circumstances can be made.

With reference to FIG. 5, expanded cylindrical region 26 can be abrasively formed into a hollow cone preparation after curing of the glue or cement that, as a general rule, is carried out up to the region of main body 12 in order to be able to temporarily insert a prefabricated Frasaco strip dental crown for example. A taken mold can serve to manufacture the dental crown at a dental lab.

Alternatively, however, there is also the possibility to immediately supplement the occurred stump with stepped cylinder 22 to a tooth-colored dental crown by means of tooth-colored composites after grinding expanded region 26 of stepped cylinder 22. Thus, the patient immediately receives a new dental crown produced by the treating dentist. If, depending on the state of root canal 16, a virtually healthy nerve and pulp issue are removed as a result of the exposure caused by the fracture during the same session, a root filling may be inserted during several sessions after termination of the usual root treatment. Hence, depending on the state of tooth 10, the appropriate treatment can be carried out based on the particular clinical situation, since through-bore 28 provided in superstructure body 22 allows a new bore to be inserted into a cured root filling mass even subsequently and for example also glue in place a locking pin in the transition region between dentin and stepped cylinder 22 for additional stabilisation.

FIG. 6 shows restored tooth 10 with dental crown 30 seated on superstructure body 22 and pin 32 glued in place in bore 20 and root canal 16. The structure and function of pin 32 is described in greater detail infra.

Stepped cylinder 22, which as a duplicate part is easily producible in large quantities, allows the construction of a dental crown in a very economic manner with comparatively simple, recurrent work steps, so that a saving of costs may not only be expected as a result of the simple superstructure body, but also as a result of the rationalised restoration procedure at the dentist. Due to through-bore 28 that, where required, can be extended to the front surface of the end region, e.g. to an elongated hole or conical, superstructure body 22 is also flexible irrespective of the state of root canal 16 of a fractured or a carious tooth 10.

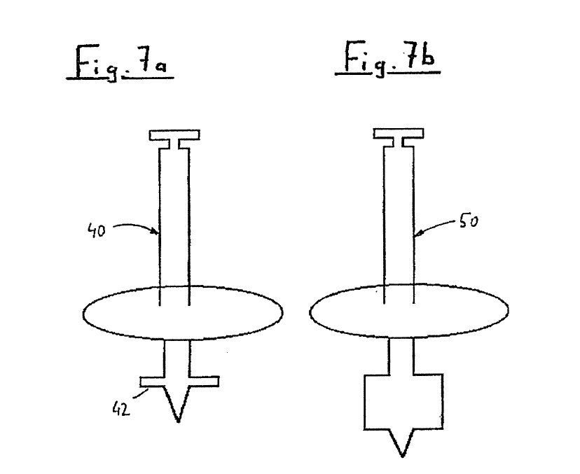

The burs shown in FIGS. 7a and b may be used as appropriate tools for the making of the indexing hole in the prepared tooth stump. Bur 40 shown in FIG. 7a has a wing form, with the outer diameter of wings 42 corresponding to the diameter of bore 20 to be inserted into the tooth stump. Also a so-called barrel shape is possible as realised by bur 50 shown in FIG. 7b.

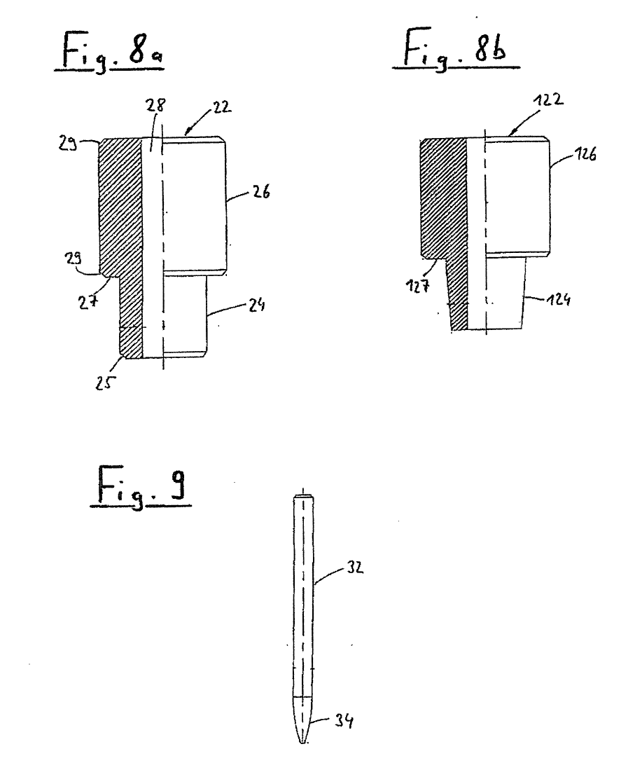

A partial cut view of a superstructure body 22 in the initial state is shown in FIG. 8a. Similar to the embodiment shown in FIGS. 1-7 and described supra, FIG. 8a shows superstructure body 22 in the form of a stepped cylinder with cylindrical end region 24, expanded cylindrical region 26 and intercostal shoulder 27. FIG. 8a further shows first chamfer 25 at the front end of smaller end region 24, which facilitates the insertion of the superstructure body into bore 20 in the dentin, and second and third chambers 29 at the flanks of expanded cylindrical region 26, which serve to prevent sharp edges.

In one embodiment of the present invention, the outer diameter of expanded cylindrical region 26 is about 44 mm, whereas smaller cylindrical region 24 has a diameter of 30 mm. Internal bore 28 has a diameter of 15 mm. Naturally, all aforementioned values are to be understood by way of example only and may be adapted to the particular intended use.

FIG. 8b shows an alternative embodiment of superstructure body 22 wherein end region 124 is designed frustoconically, i.e. end region 124 tapers towards its front end. Shoulder 127 constituting the transition to expanded cylindrical region 126 is in turn attached to end region 124. A frustonconical end region 124 may facilitate insertion in case of an adequate execution of bore 20 in the dentin and provides for an improved seat directly after the insertion.

FIG. 9 shows pin 32, as it is also shown in FIG. 6. Pin 32 has a slightly smaller outer diameter than bore 28 of superstructure body 22, so that it is insertable into those with loose fit. Pin 32 includes pointed end 34 so that pin 32 can penetrate into root canal 16 when inserted. For better anchorage of superstructure body 22, pin 32 is inserted in tooth 10, such that it connects to superstructure body 22 and/or root canal 16 by means of customary adhesive materials.

What is claimed is:

1. A superstructure body for a dental crown superstructure system on a tooth stump, wherein said tooth stump includes a root canal having a diameter and is provided with a bore, the superstructure body comprising a rotationally symmetrical first end region having a front surface, and a diameter greater than the diameter of the root canal, said first end region being insertable and anchorable in said bore of said tooth stump, and wherein a through-bore is operatively arranged in said superstructure body such that when said superstructure body is inserted into said bore, said first end terminates at said root canal such that said through-bore is in fluid communication with said root canal.

2. (canceled)

3. The superstructure body recited in claim 1 wherein said first rotationally symmetrical end region includes a central axis of rotation, and wherein said through-bore is substantially disposed along said central axis of rotation.

4. The superstructure body recited in claim 1 further comprising a second end region.

5. The superstructure body recited in claim 4 wherein said second end region is cylindrical and arranged concentrically with respect to said rotationally symmetrical first region.

6. The superstructure body recited in claim 4 wherein said first and second end regions share a common axis of rotation, and wherein said first and second end regions define a shoulder having a surface disposed substantially orthogonal to said central axis of rotation.

7. The superstructure body recited in claim 4 wherein said first and second end regions are cylindrical and have substantially equal diameters.

8. (canceled)

9. (canceled)

10. (canceled)

11. The superstructure body recited in claim 1 wherein said superstructure body is abrasively modelable.

12. (canceled)

13. (canceled)

14. The superstructure body recited in claim 1 wherein said superstructure body comprises a thermoplastic material.

15. The superstructure body recited in claim 14 wherein said thermoplastic material comprises a polyamide consisting of a condensation polymer of a bivalent alkane acid and a bivalent alkanamine.

16. The superstructure body recited in claim 14 wherein said thermoplastic material comprises a polyester consisting of a condensation polymer of a bivalent organic acid and a bivalent organic hydroxy compound.

17. The superstructure body recited in claim 14 wherein said thermoplastic material comprises a copolymer of polyester and polyamide.

18. The superstructure body recited in claim 14 wherein said thermoplastic material is comprises a polycarbonate consisting of a condensation polymer of carbonic acid and a bivalent organic hydroxy compound.

19. The superstructure body recited in claim 14 wherein said thermoplastic material is comprises a polyether.

20. The superstructure body recited in claim 14 wherein said superstructure body is manufactured by an injection molding process.

21. (canceled)

22. (canceled)

23. The superstructure body recited in claim 1 wherein said superstructure body comprises at least first and second components that are fixable to one another.

24. The superstructure body recited in claim 23 wherein said at least first component includes said first end region and said second component is fixable to said first component such that said second component extends away from said tooth stump after said first end region is inserted into said bore.

25. The superstructure body recited in claim 1 wherein said superstructure body comprises a thermosetting material.

26. The superstructure body recited in claim 25 wherein the thermosetting material comprises an epoxy resin.

27. The superstructure body recited in claim 26 wherein said superstructure body is made from monomers by a curing process.

28. A superstructure body for a dental crown superstructure system on a tooth stump, wherein said tooth stump includes a bore and a root canal having a diameter, the superstructure body comprising:
a longitudinal axis having first and second axial ends;
a rotationally symmetrical first end region having a front surface and a diameter greater than said diameter of said root canal, said first end region being anchorable in said bore;
a second end region having a back surface and a diameter greater than said diameter of said first end region; and,
a through-bore, wherein said first end region is coupled to said second end region along said longitudinal axis such that said front surface is disposed at said first axial end and said back surface is disposed at said second axial end, wherein said through-bore is disposed along said longitudinal axis and extends from said front surface to said back surface, and wherein said through-bore is in fluid communication with said root canal when said first end region is anchored in said bore.

29. The superstructure body recited in claim 28 wherein said first end region is frustoconical.

30. The superstructure body recited in claim 28 wherein said first end region is cylindrical.
